(19) United States
(12) Patent Application Publication
(10) Pub. No.: US 2010/0212699 A1
(43) Pub. Date: Aug. 26, 2010

(54) APPARATUS FOR CLEANING CONTAINERS

(75) Inventors: Frank Theising, Husum (DE); Bernd Hansen, Rantrum (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/709,638

(22) Filed: Feb. 22, 2010

(30) Foreign Application Priority Data
Feb. 23, 2009 (DE) 102009010182.9

(51) Int. Cl. B08B 3/00

(52) U.S. Cl. 134/70

(57) ABSTRACT

An apparatus for cleaning containers, equipped with a spraying device for cleaning liquid and with a conveying device for transporting the containers in a predetermined conveying direction through a plurality of cleaning stations arranged one after the other, each of the cleaning stations comprising a supply line for supplying cleaning agent to the spraying device and being equipped with a return device with which used cleaning agent can be transferred from a cleaning station succeeding in conveying direction into a preceding cleaning station. To make the apparatus more economical, the return device is provided with a return line terminating in the supply line leading to the spraying device.

### CROSS-REFERENCE TO RELATED APPLICATION

The present application claims the benefit of priority of German Application No. 102009010182.9, filed Feb. 23, 2009. The entire text of the priority application is incorporated herein by reference in its entirety.

### FIELD OF THE DISCLOSURE

The present disclosure refers to an apparatus for cleaning containers such as used in beverage bottling operations.

### BACKGROUND

The present disclosure is particularly used when bottles or other beverage containers are cleaned before being filled with drinks. High demands are made on the cleaning process for such containers. On the one hand, the containers should be optically clean and shiny; on the other hand, the containers should be brought into a hygienically impeccable state before their filling so as to prevent the drink as much as possible from being contaminated with microorganisms. When returnable containers are used, the label or other identifying means as well as the adhesives for their attachment must be removed without any residues. This exacting cleaning process is carried out in a plurality of cleaning stations which the container must pass through in successive order. Such cleaning stations include e.g. caustic solution treatments of different forms, and then rinsing treatments in which only water is used as the cleaning liquid. As a rule, rinsing is first carried out with hot and then with cold water, which is followed in the end by fresh-water rinsing to remove ultimate contamination and to cool the containers, if necessary. As a consequence, the consumption of cleaning liquid, especially water consumption, and of energy is considerable. That is why attempts have been made time and again to save these resources. For instance, the water of the last cleaning stage(s) that was collected in collecting containers has so far been returned in cascaded fashion over an overflow plate into collecting containers of preceding cleaning stations, so that the water from the last cleaning stations that shows a relatively low soiling degree dilutes the cleaning liquids in the upstream cleaning stations. The cleaning agent of a succeeding cleaning station that is relatively clean is thereby used once again in a preceding cleaning station where it can receive another dirt load (caustic solution). The known design has so far been used for rinsing the containers after these had passed through various caustic treatment baths. The water-return principle was employed between a succeeding cold-water collecting tank and a preceding warm-water collecting tank and also between a succeeding hot-water tank and a second preceding hot-water tank. This design has the drawback of a relatively low degree of dilution which the returned water exerts on the more dirt-loaded water reservoir in the collecting container of the preceding cleaning station because the returned water is always mixed with the total water volume of the preceding cleaning station.

### SUMMARY OF THE DISCLOSURE

It is therefore an aspect of the present disclosure to provide an apparatus for cleaning containers that offers a more efficient exploitation of the cleaning liquid used.

The disclosed return of the “cleaner” cleaning liquid of a succeeding cleaning process directly into the supply line for spraying the containers in up receding cleaning process effects a much stronger degree of dilution of the cleaning liquid because the volume amounts in the supply line are much smaller than the whole circulating amount of cleaning liquid in said cleaning station. This means that the cleaning liquid used for spray-washing the containers in the preceding cleaning process is always “cleaner” than the cleaning liquid circulated in said cleaning station. For instance, the remaining alkalinity from a preceding caustic solution treatment can thereby be decomposed in an improved way and the containers can be cooled more efficiently after a hot-water treatment.

This is particularly true for cleaning stations that comprise a collecting container for used cleaning liquid, from which the cleaning liquid is continuously taken for spray-washing the containers and in which the cleaning liquid is again collected after the spray-washing operation. Such collecting containers show a relatively great receiving capacity so that during the disclosed return into the supply line the percentage proportion of the diluted clean cleaning liquid from the subsequent cleaning process is particularly strongly increased in relation to the volume share of the cleaning liquid circulated in the preceding cleaning process.

The return line preferably terminates over an overflow which displays a collecting action.

With the return line terminating upstream of the pump, a uniform mixing operation is ensured.

A filter guarantees that coarse dirt can be filtered out of the collecting container.

The supply of fresh water for replenishing the cleaning agent portion that has been entrained through the containers out of the cleaning system, or other losses, is preferably carried out again by returning already used cleaning liquid from the last rinsing operation.

The disclosure is applicable to any cleaning system in which several cleaning stations are provided using the same type of cleaning liquid.

### BRIEF DESCRIPTION OF THE DRAWINGS

An embodiment of the disclosure will now be explained in detail with reference to the sole drawing, which is a very schematized illustration showing a scheme of the apparatus according to the disclosure.

### DETAILED DESCRIPTION OF THE PREFERRED EMBODIMENT

The figure shows a section of an apparatus 1 for cleaning containers 2. The containers 2 may be of very different types, but are preferably beverage containers and particularly beverage bottles. The apparatus 1 may be configured as a one-ended or double-ended cleaning machine and, in the illustrated embodiment, it is arranged upstream of a filling machine for filling the containers 2 with beverages, but it can be used in all cases where containers must be cleaned in a particularly clean and/or hygienically impeccable way.

The containers 2 are arranged on one of the standard conveying devices 3, with the conveying devices 3 transporting the containers 2 in conveying direction F, preferably continuously, through the apparatus 1.

In the apparatus 1, there are a multitude of cleaning stations 4 through which the containers 2 pass in conveying direction F one after the other for a cleaning treatment. Shown is a first cleaning station 4.1, a second cleaning station 4.2, a third cleaning station 4.3, a fourth cleaning station 4.4, and a fifth cleaning station 4.5; the number of the cleaning stations is however optional and can be matched to the desired cleaning result.

In each of the cleaning stations 4, as are here shown, the containers 2 are treated with a cleaning liquid. The illustrated section of the cleaning apparatus 1 shows a treatment of the containers 2 with an after treatment caustic solution in the area of the first cleaning station 4.1, and a treatment of the containers 2 with the same type of cleaning liquid in the cleaning stations 4.2 to 4.5, here e.g. a rinsing device for rinsing the containers 2 with water. The rinsing operation may here be carried out in the second cleaning station 4.2 with hot water at a first temperature, in the third cleaning station 4.3 with hot water at a second lower temperature, in the fourth cleaning station 4.3 with cold water and in the fifth cleaning station 4.5 with fresh water.

The disclosure, however, can be used not only for rinsing containers 2 with water, but whenever several rinsing operations are to be carried out with a cleaning liquid of the same type.

Each of the first four cleaning stations 4.1 to 4.4 contains a collecting container 5.1 to 5.4, said collecting containers being arranged underneath the conveying device 3. Each cleaning station further contains a spraying device 7.1, 7.2, 7.3, 7.4 and 7.5 supplied by a supply line 6.1, 6.2, 6.3, 6.4 and 6.5 with cleaning agent for spray-washing the containers 2. The supply lines 6.1 to 6.4 of the cleaning stations 4.1 to 4.4 are here in communication with the associated collecting containers 5.1 to 5.4, the cleaning liquid being here conveyed by circulation from the respective collecting container 5.1 to 5.4 to the spraying device 7.1 to 7.4 of the same cleaning station 4.1 to 4.4, passed over or into the containers 2 and then collected again. The spraying device 7.1 to 7.5 may have any appropriate design and, in the illustrated embodiment, it contains—in each of the cleaning stations 4.1 to 4.4—an upper nozzle or nozzle group 8 that sprays cleaning liquid from above onto or into the containers 2, and a lower nozzle or nozzle group 9 that sprays cleaning liquid from below onto or into the containers 2, as is e.g. described in EP 1 144 016. Each of the supply lines 6.1 to 6.4 contains a pump 10.1 to 10.4 and a filter 11.1 to 11.4 arranged upstream of the pump. Pump 10 and filter 11 are of the conventional type.

The cleaning station 4.5 that is the last one in conveying direction F serves clear-rinsing purposes with a fresh cleaning agent, particularly with fresh water, and just contains the lower nozzle or nozzle group 9, but by analogy with the other spraying devices it may be provided with upper and lower nozzles. The last cleaning station 4.5 is without any collecting container, but comprises a trough or collecting plate 13 which is inclined for collecting the accumulated cleaning liquid. The cleaning station 4.5 that is the last one in conveying direction F is again equipped with a supply line 6.5 that is connected to a source of fresh water and leads to a spraying device 7.5, which in the illustrated embodiment just contains the lower nozzles or the lower nozzle group 9.

Cleaning liquid is gradually returned via a return device 12 from downstream cleaning stations into upstream cleaning stations in which the use of fresh cleaning agent is expedient and recommended, for instance, to normalize the pH and/or the temperature (i.e. after a caustic-solution and hot-water treatment to reduce the pH and the temperature) or to dilute the dirt load. In the illustrated embodiment these are the fourth cleaning station operating with cold water and the third and second cleaning station, both operating with hot water.

The return device 12 is each time provided with a return line 12.1, 12.2, and 12.3, the return line 12.1 establishing a flow connection between the fifth and the fourth cleaning station 4.5 and 4.4, the return line 12.2 a connection between the fourth cleaning station and the third cleaning station 4.3, and the return line 12.3 a flow connection between the third cleaning station 4.3 and the second cleaning station 4.2.

The return line 12.1 is arranged with its orifice 14.1 at or near the lowest point of the trough 13, whereas the orifices 14.2, 14.3 of the return lines 12.2 and 12.3 are arranged in the associated collecting container 5.4 and 5.3, respectively, and configured as an overflow that simultaneously determines the fill level of the respective collecting container 5.3 and 5.4, respectively. In particular, the orifice 14.1 of the return line 12.1 is arranged in the collecting container 5.4 of the fourth cleaning station 4.4 and the orifice 14.2 of the return line 12.2 in the collecting container 5.3 of the third cleaning station 4.3.

The return lines 12.1 to 12.3 terminate with their other ends in the supply line 6.4, 6.3, 6.2 of the respectively preceding cleaning station 4.4, 4.3, 4.2. In particular, the return line 12.1 connects the trough 13 of the fresh-water station to the collecting container 5.4 of the fourth cleaning station, the cold-water station, the return line 12.2 the collecting container 5.4 to the supply line 6.3 of the third cleaning station 4.3, the second hot-water station, and the return line 12.3 the collecting container 5.3 to the supply line 6.2 of the second cleaning station 4.2. The incorporation of the return lines 12.1, 12.2, 12.3 into the supply lines 6.4, 6.3, 6.2 is each time carried out upstream of the pump 10 and the filter 11.

Return lines of the type as described may also be provided between the second collecting container 5.2 and the first collecting container 5.1, respectively, and collecting containers located further upstream, on condition that these operate with the same cleaning agent, or on condition that a mixing of the cleaning agents of the different cleaning stations is not objectionable. Furthermore, it is also possible to just connect selected cleaning stations among a group of stations operating with cleaning agent of the same type to a return line.

In the illustrated embodiment, the return operation ends at the second cleaning station 4.2, the second cleaning station 4.2, however, being also provided with an overflow 14.4, which in the already described way limits the fill level in the collecting container 5.2 of the second cleaning station 4.2. The line 15 which is connected to the overflow 14.3 leads, however, either into a disposal device or to the further use of the removed cleaning agent, e.g. for exploiting the heat content of the cleaning liquid from the second cleaning station 4.3, or the like.

The collecting container 5.1 of the first cleaning station 4.1 is also provided in the same way with an overflow 14.5 that is connected to a line 16 through which the caustic solution contained in the collecting container 5.4 (in the illustrated embodiment) is either withdrawn to be disposed off or, by analogy with the above-described return device in the rinsing area, is again used in a preceding cleaning step.

During operation of the apparatus 1 of the disclosure the containers 2 are passed through the apparatus 1, so that they first enter into the first cleaning station 4.1 and are there treated with cleaning liquid from the collecting container 5.1. The containers then pass gradually through the second, third and fourth cleaning station 4.2 to 4.4 in which they are each treated with the cleaning agent from the associated collecting container 5.2 to 5.4, the cleaning agent being respectively supplied via the associated supply line 6.2 to 6.4 of the associated spraying device 7.2 to 7.4 (this is effected by the pumps 10.2 to 10.4). Subsequently, the containers 2 pass into the cleaning station 4.5, which is the last one in the illustrated embodiment, where they are clear-rinsed with a gush of freshly supplied cleaning agent, in the illustrated embodiment with a gush of fresh water via the supply line 6.5 and the nozzle 9. The cleaning agent that drips off again from the containers 2 passes via the trough 13, the orifice 14.1 and the return line 12.1 into the supply line 6.4 of the preceding cleaning station 4.4 and dilutes the cleaning agent that is there sucked off by the pump 10.4 out of the collecting container 5.4. The cleaning agent runs over the containers 2 and drips again into the collecting container 5.4. If the level in the collecting container 5.4 of the fourth cleaning station 4.4 rises up to the overflow 14.2, the cleaning agent is returned from the collecting container 5.4 via the return line 12.2 into the supply line 6.3 of the preceding cleaning station 4.3 and passes there into the cleaning agent stream that is sucked off by the pump 10.3 out of the collecting container 5.3 of the third cleaning station 14.3. The cleaning agent diluted in this way then passes into the spraying device 7.3 and is guided over the containers 2. Subsequently, the cleaning liquid drips again into the collecting container 5.3.

If in the collecting container 5.3 the predetermined maximum level is reached, the cleaning agent passes out of the collecting container 5.3 into the return line 12.3 and is fed from said line into the supply line 6.2 of the second preceding cleaning station 4.2, passes there into the cleaning agent stream, which is sucked off by the pump 10.2 out of the collecting container 5.2 of the second cleaning station 14.2, and then passes into the spraying device 7.2 and is guided over the containers 2. Subsequently, the cleaning liquid drips off again into the collecting container 5.2. lithe level in the second collecting container 4.2 has been exceeded, the cleaning agent can be removed via the overflow 14.4 and line 15.

Since the volume of the supply line 6 is much smaller than the volume of the associated collecting container 5, a much more efficient mixing or diluting with a higher ratio factor can here take place by way of the return line terminating in said container than would e.g. be the case if an overflow existed between and among the collecting containers. Since the cleaning agent from the subsequent cleaning stage is normally not so much dirtied or not so much loaded with caustic cleaning solution as the cleaning agent issuing from the preceding cleaning station, the cleaning liquid of the preceding cleaning stage is improved, i.e. diluted, due to the returning process via the return line.

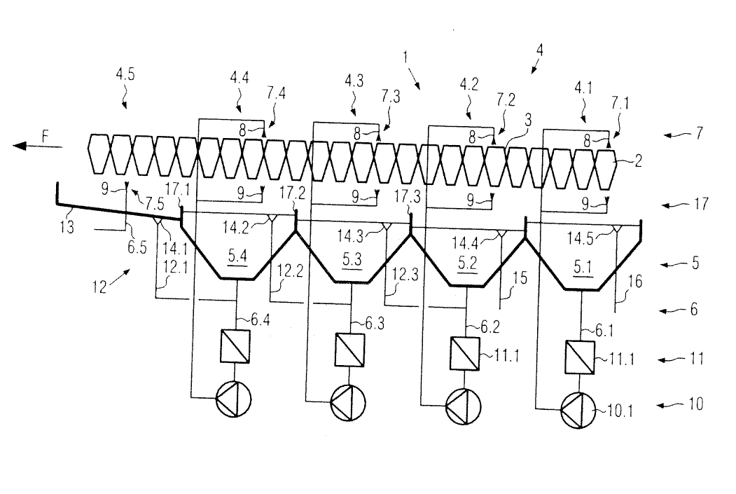

If the collecting containers 5 and the trough 13, as shown in FIG. 1, are arranged as neighbors and in a vertically staggered configuration, a direct overflow 17 may be additionally provided between suitable cleaning stations 4, which however will preferably only become operative if the return line is overburdened and there is a risk of spilling. Such a safety overflow 17.1, 17.2, 17.3 may e.g. be provided between the trough 13 and the fourth collecting container 5.4 and between the collecting containers 5.4 and 5.3 as well as 5.3 and 5.2.

In a practical test, mixing ratios of 1:5 were achieved, i.e. one part of “improved” cleaning liquid from a succeeding cleaning stage to five parts of the cleaning liquid that is sucked in by the pump 10 and pertains to a preceding cleaning stage.

Practical tests were carried out with the following operating parameters:

| | |
|---|---|
| Internal spraying | 14 m³/h |
| External spraying | 12 m³/h |
| Total | 26 m³/h |

Contents of the collecting container:

| | | |
|---|---|---|
| Cold water (5.4) | 0.49 | m³ |
| Hot water (5.2, 5.3) | 0.56 | m³ |
| Fresh water (6.5) | 5 | m³/h |

It was found that with the design of the disclosure the containers were better cooled and the decomposition of alkalinity was optimized. A rough estimation by way of a heat quantity calculation shows a reduction of the spraying temperature by about 2° C. The containers were thereby spray-washed with a colder and less alkaline liquid.

In a modification of the described and plotted embodiment the disclosure can also be used in other cleaning devices in which cleaning liquid is to be exploited in an optimum way. Depending on the type of container and the cleaning job, other nozzles assemblies or other nozzle combinations or other designs of spraying devices may be provided.

1. An apparatus for cleaning containers, comprising a spraying device for cleaning liquid, a conveying device for conveying the containers in a predetermined conveying direction through a plurality of cleaning stations arranged one after the other, each of said cleaning stations including a supply line for supplying cleaning agent to the spraying device, and a return device with which used cleaning agent can be transferred from a cleaning station succeeding in conveying direction into a preceding cleaning station, the return device containing a return line terminating in the supply line leading to the spraying device.

2. The apparatus according to claim 1, wherein the preceding cleaning station comprises a collecting container from which the supply line is led out.

3. The apparatus according to claim 1, wherein the return line comprises an orifice connected to an overflow.

4. The apparatus according to claim 1, wherein the supply line is connected to a pump, and the return line ends downstream of the pump in the supply line.

5. The apparatus according to claim 4, and wherein a filter is arranged after the orifice of the return line and in front of the pump.

6. The apparatus according to claim 1, wherein a last cleaning station in a conveying direction is a fresh-water cleaning station, the used cleaning liquid of which is introduced into a collecting container of the second-to-last cleaning station in the conveying direction.

7. The apparatus according to claim 1, wherein in the conveying direction of the containers at least one warm-water cleaning station and at least one cold-water cleaning station are arranged, with a return device being provided between the cold-water and the hot-water stations and between neighboring cold-water and hot-water stations.

8. A method for cleaning containers (2), in which cleaning liquid is returned from a succeeding cleaning step into a preceding cleaning step, comprising returning the cleaning liquid directly into a supply line leading to a spraying device of the preceding cleaning step.
